(19) United States
(12) Patent Application Publication
(10) Pub. No.: US 2025/0005407 A1
(43) Pub. Date: Jan. 2, 2025

(54) ONLINE MATCHING OPTIMIZATION DEVICE, METHOD AND PROGRAM

(71) Applicant: NIPPON TELEGRAPH AND TELEPHONE CORPORATION, Tokyo (JP)

(72) Inventors: Yuya HIKIMA, Musashino-shi (JP); Yasunori AKAGI, Musashino-shi (JP); Naoki MARUMO, Musashino-shi (JP); Hideaki KIN, Musashino-shi (JP); Taichi ASAMI, Musashino-shi (JP)

(73) Assignee: NIPPON TELEGRAPH AND TELEPHONE CORPORATION, Tokyo (JP)

(21) Appl. No.: 18/696,380

(22) PCT Filed: Sep. 29, 2021
(86) PCT No.: PCT/JP2021/035897

§ 371 Date: Mar. 28, 2024

(51) Int. Cl. G06N 7/01; G06F 16/9535; G06Q 10/04

(52) U.S. Cl. CPC G06N 7/01; G06F 16/9535; G06Q 10/04

(57) ABSTRACT

In one aspect of the present invention, parameters including a probability function defining an appearance probability of a first node for a plurality of times, a reward assigned when an edge is matched with a set of edges associating a set of first nodes with a set of second nodes for the plurality of times, and a period of time required until the second node corresponding to the matched edge is available again for the plurality of times is acquired. A first optimization problem formulated using the obtained parameter information is defined, a variable for controlling the reward of the edge and the appearance probability, and a matching strategy for designating the second node to be allocated to the appearing first node are determined as the optimal solution by solving the formulated first optimization problem, and the determined variables and matching strategy are output.

### TECHNICAL FIELD

One aspect of the present invention relates to an optimization device, method, and program used to obtain an optimal solution to an optimization problem, for example, in online matching regarding a bipartite graph.

### BACKGROUND ART

In online matching, u∈U is assigned to v∈V appearing at each time t when a node set U present in advance and a node set V that can appear in the future are given in a special matching problem regarding a bipartite graph G=(U, V, E).

An application example of online matching is, for example, the allocation of Internet advertisements. In this example, a given advertising frame (U) is allocated to a website viewer (V), in which a website on which the website viewer will appear is not known in advance. In addition, examples of other application examples include crowdsourcing for allocating tasks (U) to be solved to workers (V) that appear sequentially via the Internet, and a taxi platform for allocating available taxis (U) to sequentially appearing orderers (V).

Incidentally, as a solution to an optimization problem of online matching, for example, a technology for determining a matching strategy such that an expected weight of resulting matching is large when a reward wₑₜ when each edge e∈E has been allocated in each time t, and a probability pᵥₜ that each user v∈V will appear in each time t are given as predetermined ones is known (see NPL 1, for example).

As another technology, a solution to an optimization problem with an expected value of a function as an objective function is also known. For example, this solution is a solution for searching for a variable x such that an expected weight of resulting matching is large when a reward when each edge e∈E has been allocated, a probability that each node v∈V will appear, and a matching strategy n are given as predetermined ones in online matching (see NPL 2, for example).

### CITATION LIST

### Non Patent Literature

[NPL 1] John Dickerson, Karthik Sankararaman, Aravind Srinivasan, and Pan Xu. “Allocation problems in ride-sharing platforms: Online matching with offline reusable resources.” In Proceedings of the AAAI Conference on Artificial Intelligence, Vol. 32, 2018.
[NPL 2] Warren Scott, Peter Frazier, and Warren Powell. “The correlated knowledge gradient for simulation optimization of continuous parameters using Gaussian process regression.” SIAM Journal on Optimization, Vol. 21, No. 3, pp. 996-1026, 2011.

### SUMMARY OF INVENTION

### Technical Problem

However, the technology described in NPL 1 only proposes a matching strategy n such that an expected weight of matching is increased, and does not consider that a reward when each edge e∈E is allocated and a probability that each node v∈V will appear are controlled by the variable x, and a method of simultaneously optimizing the matching strategy n and the variable x is not shown at all.

In addition, although the technology described in NPL 2 describes a scheme for searching for the variable x, the NPL 2 does not describe determining the matching strategy n at all, and thus, a scheme of simultaneously optimizing the matching strategy n and the variable x is not shown at all.

The present invention has been made in view of the above circumstances, and an object thereof is to provide a technology for simultaneously optimizing both a matching strategy and a variable capable of controlling an appearance probability of nodes and a reward of an edge.

### Solution to Problem

In order to solve the above problems, in an aspect of the online matching optimization device or optimization method according to the present invention, when an optimal solution is determined from an optimization problem defined in online matching for allocating a second node prepared in advance to a first node appearing at an arbitrary time, parameter information including a probability function defining an appearance probability of the first node for a plurality of times, a reward assigned when an edge is matched with a set of edges associating a set of first nodes with a set of second nodes for the plurality of times, and a period of time required until the second node corresponding to the matched edge is available again for the plurality of times is acquired. A first optimization problem formulated using the obtained parameter information is defined, a variable for controlling the reward of the edge and the appearance probability, and a matching strategy for designating the second node to be allocated to the appearing first node are determined as the optimal solution by solving the formulated first optimization problem, and the determined variables and matching strategy are output.

According to an aspect of the present invention, it is possible to simultaneously determine both a variable capable of controlling an appearance probability of the first node and the reward of the edge, and the matching strategy n as the optimal solution.

### Advantageous Effects of Invention

That is, according to an aspect of the present invention, it is possible to provide a technology for simultaneously optimizing both a matching strategy and a variable capable of controlling an appearance probability of nodes and a reward of an edge.

### BRIEF DESCRIPTION OF DRAWINGS

FIG. 1 is a diagram illustrating an example of an application system including an optimization device according to an embodiment of the invention.

FIG. 2 is a block diagram illustrating a hardware configuration of the optimization device in the embodiment of the invention.

FIG. 3 is a block diagram illustrating a software configuration of the optimization device in an embodiment of the invention.

FIG. 4 is a flowchart illustrating an example of a procedure and content of processing executed by the optimization device illustrated in FIG. 3.

FIG. 5 is a flowchart illustrating an example of a procedure and processing content of optimization processing in the processing procedures illustrated in FIG. 4.

FIG. 6 is a diagram illustrating a special online matching optimization problem regarding a bipartite graph G=(U, V, E) addressed by the optimization device according to the embodiment of the invention.

FIG. 7 is a diagram illustrating the optimization problem illustrated in FIG. 6.

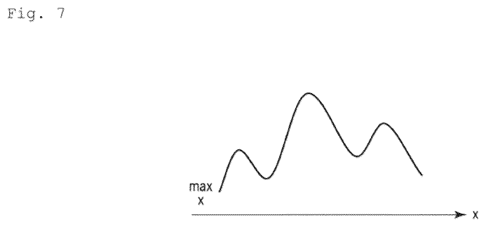

FIG. 8 is a diagram simply illustrating an optimum value of the optimization problem obtained by approximating an objective function of the optimization problem illustrated in FIG. 7, and a ½ approximation solution thereof.

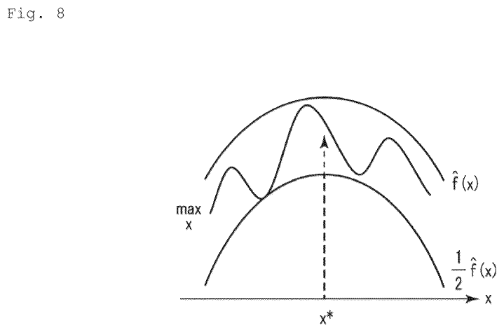

### DESCRIPTION OF EMBODIMENTS

Hereinafter, embodiments of the present invention will be described with reference to the drawings.

### One Embodiment

### Configuration Example

### (1) System

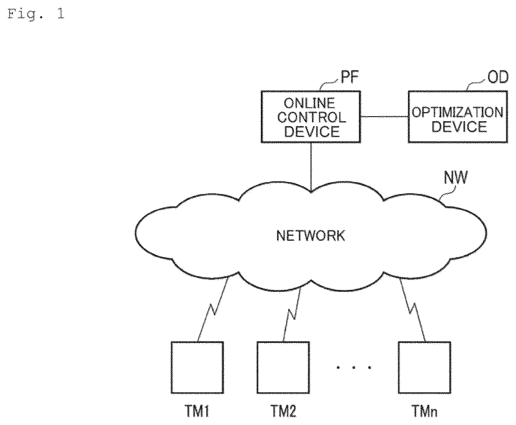

FIG. 1 is a diagram illustrating an example of an application system including an optimization device in an embodiment of the invention.

The application system is a system that provides online services, and corresponds to, for example, a crowdsourcing system that assigns tasks to sequentially appearing workers via the Internet, and a taxi platform that assigns available taxis to sequentially appearing users.

The application system according to the embodiment includes an online control device PF that functions as a matching platform. The online control device PF controls allocation of nodes that are allocation targets, and is accessible via a network NW from a plurality of user terminals TM1 to TMn used by users who want to use online services.

The network NW is configured of, for example, the Internet and an access network thereof. As an access network, for example, a public wireless network that adopts standards such as 4G or 5G, a public optical communication network, or the like are used, but a wireless network such as WiFi (registered trademark), a wired local area network (LAN), or the like may be used, but and the present invention is not limited thereto.

The online control device PF is configured of, for example, a server computer provided on the Web or cloud, and the optimization device OD according to the embodiment of the present invention is connected to the online control device PF. The optimization device OD may be provided as some of functions of the online control device PF.

### (2) Optimization Device OD

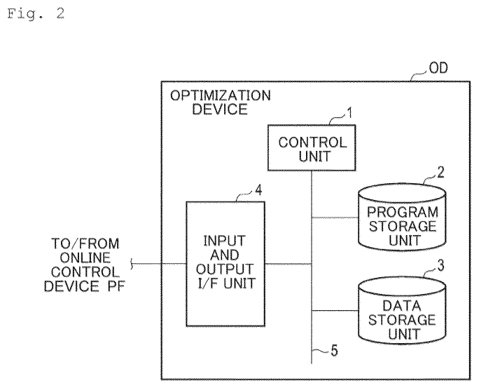

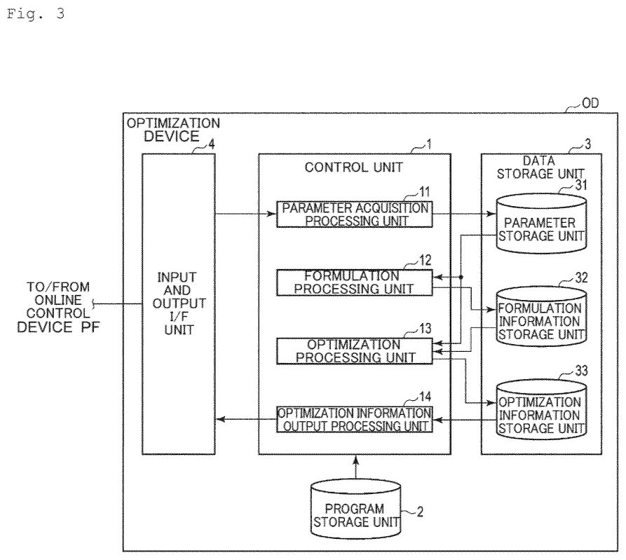

FIG. 2 is a block diagram illustrating an example of a hardware configuration of the optimization device OD in an embodiment of the present invention, and FIG. 3 is a functional block diagram illustrating an example of a software configuration of the optimization device OD.

The optimization device OD is configured, for example, of a server computer or a personal computer. The optimization device OD includes a control unit 1 using a hardware processor such as a central processing unit (CPU), and a storage unit including a program storage unit 2 and a data storage unit 3 and an input and output interface (hereinafter the interface is referred to as I/F) unit 4 are connected to the control unit 1 via a bus 5. The optimization device OD may additionally include a communication I/F unit and the like.

The input and output I/F unit 4 is used to receive various parameters input from the online control device PF and to output the optimal solution obtained by the control unit 1 to the online control device PF.

The program storage unit 2 is, for example, a combination of a non-volatile memory such as a hard disk drive (HDD) or solid state drive (SSD) that can be written to and read at any time and a non-volatile memory such as a read only memory (ROM) as a storage medium, and stores various programs necessary for execution of various types of control processing according to an embodiment of the present invention, in addition to middleware such as an operating system (OS).

The data storage unit 3 is, for example, a combination of a non-volatile memory, such as an HDD or an SSD, which can be written and read at any time, and a volatile memory, such as a random access memory (RAM), as a storage medium, and includes a parameter storage unit 31, a formulation information storage unit 32, and an optimization information storage unit 33 as storage areas necessary for carrying out the embodiment of the present invention.

The parameter storage unit 31 is used to store a plurality of parameters that define the optimization problem, which are input from the online control device PF. A relational expression representing the optimization problem that is an addressing target is also stored in in the parameter storage unit 31.

The formulation information storage unit 32 is used to store the relational expression formulating the optimization problem, which is generated by the control unit 1.

The optimization information storage unit 33 is used to store the optimal solution of the formulated optimization problem derived by the control unit 1.

The control unit 1 includes a parameter acquisition processing unit 11, a formulation processing unit 12, an optimization processing unit 13, and an optimization information output processing unit 14 as processing functions according to an embodiment of the present invention. Each of these processing units 11 to 14 is realized by causing the hardware processor of the control unit 1 to execute an application program stored in the program storage unit 2. The application program may not be stored in the program storage unit 2 in advance, and may be downloaded from, for example, the online control device PF when necessary.

The parameter acquisition processing unit 11 performs processing for acquiring the parameters input from the online control device PF via the input and output I/F unit 4 and storing the acquired parameters in the parameter storage unit 31 when executing processing for obtaining the optimal solution of the optimization problem.

The formulation processing unit 12 performs processing for reading the relational expression of the optimization problem from the parameter storage unit 31, formulates the relational expression, and stores the formulated relational expression of the optimization problem in the formulation information storage unit 32.

The optimization processing unit 13 performs processing for calculating the optimal solution from the formulated relational expression of the optimization problem on the basis of the parameters stored in the parameter storage unit 31, and storing the calculated optimal solution in the optimization information storage unit 33. For the optimal solution, both the variable x that can control the appearance probability of the user v as the first node and the reward wₑₜ of the edge e and the matching strategy n are simultaneously calculated.

The optimization information output processing unit 14 performs processing for reading the optimal solution obtained by the optimization processing from the optimization information storage unit 33, and outputting the read optimal solution from the input and output I/F unit 4 to the online control device PF.

### Operation Example

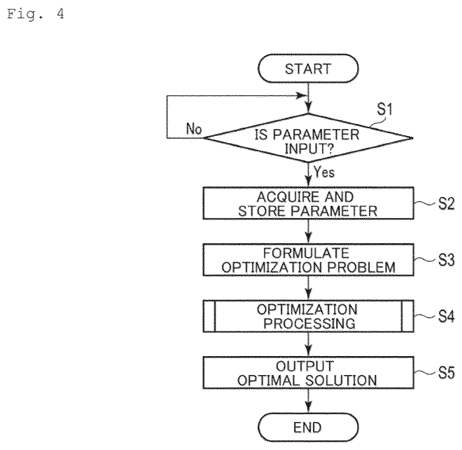

Next, an operation example of the optimization device OD configured as described above will be described. FIG. 4 is a flowchart illustrating an example of a procedure and content of processing executed by the optimization device OD.

In an embodiment, for example, in a system that provides online services, for example, an object is to control access from a user and maximize profits by presenting a monetary incentive to the user who want to receive online services, and to this end, an optimization problem for optimizing a reward for the user is defined.

### (1) Acquisition of Parameters

To define the optimization problem, the control unit 1 of the optimization device OD first acquires parameters under the control of the parameter acquisition processing unit 11. That is, the parameter acquisition processing unit 11 monitors input of parameters defining the optimization problem in step S1. When a parameter is input from the online control device PF in this state, the parameter acquisition processing unit 11 acquires the parameter through the input and output I/F unit 4 and stores the acquired parameter in the parameter storage unit 31 in step S2.

The acquired parameters include the following: That is, when v is a user as the first node, V is set thereof, u is a resource as the second node, U is a set thereof, t is a time, and T=(t1, t2, . . . , t^{max}) is a set thereof, a variable (probability function) p_{vτ} indicating a probability that a user (v∈V) will appear at each time t, a reward wₑₜ when the edge e is matched, which is assigned to each edge e∈E associating the user set (v E V) with the resource set (u∈U) for each time t, and a period of time cₐₜ required until the resource u corresponding to a case in which the edge e is used at time t becomes available again are included.

### (2) Formulation of Optimization Problem

The control unit 1 of the optimization device OD subsequently performs formulation of the optimization problem in step S3 under the control of the formulation processing unit 12.

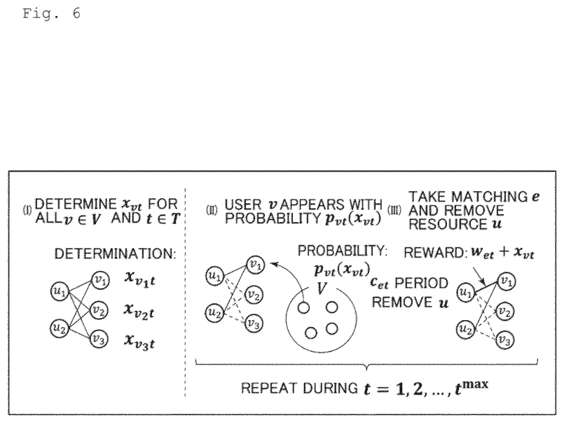

FIG. 6 is a diagram illustrating a special online matching optimization problem for a bipartite graph G=(U, V, E) addressed by the optimization device OD.

In the optimization problem, a variable xᵥₜ (v∈V, t=1, 2, . . . , t^{max}) illustrated in (I) of FIG. 6 and the matching strategy n for determining a resource u to be allocated to the user v appearing in (III) is determined, which are defined as a problem of maximizing an expected profit. This optimization problem can be formulated as follows.

That is, when the formulated optimization problem is (P), the optimization problem (P) is defined using the parameters obtained above as follows:

$${max}_{x ∈ {V \times T}^{} , π ∈ \prod } {ξ ∼ D ( x )}_{} [ f ( π , x , ξ ) ] \qquad [ Math . 1 ]$$

Here, x is a decision variable expressed as a vector having price xᵥₜ at time t for each user v∈V as an element, and n represents the matching strategy in (III) of FIG. 6, and determines which user v appearing for the resource u∈U to be assigned. Π denotes a set of all matching strategies n, and T={t1, t2, . . . , t^{max}} denotes a set of times. ξ∈(v₁, v₂, . . . , vₙ, ⊥)^{T} is a probability function representing whether or not the appearing node has been approved, ξₜ=vₖ represents that node vₖ has appeared at time t, and ξₜ=⊥ indicates that no node has appeared at time t.

Further, D(x) indicates a probability distribution of ξ∈{v₁, v₂, . . . , vₙ, ⊥}t^{max}. Also, a probability mass function thereof is expressed by Pr (ξ|t, x)=Π_{t∈T} Pr (ξₜ|t, x). Here, Pr(ξ=v|t,x)=pᵥₜ (xᵥₜ) for each v∈{v₁=i, v₂, . . . , (xᵥₜ)}, and Pr (ξ=⊥|t, x)=1−Σ_{v∈V} pᵥₜ (xᵥₜ) Also, the function f (π, x, ξ) is a sum of matching rewards obtained when the parameter (π, x, ξ) is given.

### (3) Optimization Processing for Optimization Problem

### (3-1) Solution to Optimization Problem (P)

In step S4, the control unit 1 of the optimization device OD executes processing for obtaining a variable x and the matching strategy n serving as an optimal solution from the formulated optimization problem (P) under the control of the optimization processing unit 13, as follows.

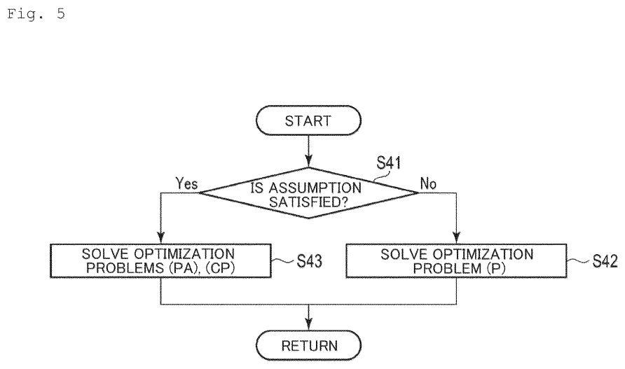

FIG. 5 is a flowchart illustrating a processing procedure and processing content of the optimization processing executed by the optimization processing unit 13.

First, in step S41, the optimization processing unit 13 determines whether or not the following “assumption” set in advance is satisfied.

“Assumption”; for all v∈V and t∈T, pᵥₜ (x) is lim_{x→∞}pᵥₜ(x)=0, but the variable x at which pᵥₜ(x)=0 is included in a domain thereof. Also, 1−pᵥₜ(x) is a monotone hazard rate function, and pᵥₜ(x) is bijective and monotonically decreasing.

The “Assumption” include a complementary cumulative distribution function of a normal distribution or Gumbel distribution as pᵤ. These distributions are distributions that are often used in the field of machine learning, and the “assumption” is a loose assumption.

When a determination is made in step S41 that the “assumption” is not satisfied, the optimization processing unit 13 solves the optimization problem (P) using, for example, a heuristic solution or an approximate solution in step S42.

### (3-2) Solution to Optimization Problem (PA)

On the other hand, when a determination is made in step S41 that the assumption is satisfied, the optimization processing unit 13 proceeds to step S43 and obtains the optimal solution from the optimization problem (PA) as follows.

First, a function of approximating a function max_{π∈Π}E_{ξ-D(x)}, [f(π, x, ξ)] is defined. A matching strategy described in NPL 1, for example, for a certain variable x is set as π^{H}(x). Also, when an optimum value of the linear programming problem is f\hat{ }(x), this optimum value f\hat{ }(x) is expressed as an optimum value of the following optimization problem.

$${max}_{z ∈ {[ 0 , 1 ]}^{E \times T}} {\sum }_{t ∈ T} {\sum }_{e = ( u , v ) ∈ E} ( {x}_{vt} + {w}_{et} ) {z}_{et} \qquad [ Math . 2 ]$$

$$s . t . {\sum }_{e ∈ δ ( v )} {z}_{et} \leq {p}_{vt} ( {x}_{vt} ) , ∀ v ∈ V , ∀ t ∈ T ,$$

$${\sum }_{{t}^{′} \leq t} {\sum }_{e ∈ δ ( u )} ϕ ( {c}_{{et}^{′}} , t , {t}^{′} ) {z}_{{et}^{′}} \leq 1 , ∀ u ∈ U , ∀ t ∈ T ,$$

$$ϕ ( {c}_{{et}^{′}} , t , {t}^{′} ) := \{ \begin{matrix}1 & {c}_{{et}^{′}} \geq t - {t}^{′} \\ 0 & otherwise .\end{matrix}$$

[symbol]

Here,
Also, δ(α) represents an edge set connected to node α.

In this case, the following inequality holds. The inequality described in NPL 1 is used as this inequality.

$$\frac{1}{2} \hat{f} ( x ) \leq {ξ ∼ D ( x )}_{} [ f ( {π}^{H} ( x ) , x , ξ ) ] \leq {max}_{π ∈ \prod } {ξ ∼ D ( x )}_{} [ f ( π , x , ξ ) ] \leq \hat{f} ( x ) \qquad [ Math . 3 ]$$

Therefore, when x*:=argmax_{x∈R}^{V×T} f\hat{ }(x), π*:=π^{H}(x*), (x*, π*) is a ½ approximation solution of the optimization problem (P).

That is, in the equation expressing the optimum value f\hat{ }(x) of the linear programming problem, a decision variable z_{u,v,t} on the first line corresponds to a probability that the resource u matches the user v at time t, and an equation on a second line indicates that an amount of allocation of the user v is not smaller than an expected value of an approval probability when the node v appears. Further, an equation on a third line indicates that an amount of allocation of the resource u can only be used up to an available amount, which changes according to the amount used at a previous time.

In other words, the optimum value f\hat{ }(x) can be said to be a problem in which the decision variable z_{u,v,t} is continuously relaxed after all expected values are taken for the probability functions.

As described above, T={1, 2, . . . , t^{max}} is a set of times, and pᵥₜ(x) represents a function for a price x indicating a probability that the user v will appear at time t, and C_{e_{t′}}∈{0, 1, 2, . . . , n} represents a period of time until the resource u become available again when the resource u is allocated to the user v at time t′.

Further, φ(C_{u,v,t,t′}) is a function that is 0 when C_{u,v,t,t′}≥−t′, and 1 otherwise. That is, this function is 0 when the resource u used at time t′ is available again at time t, and 1 when the resource u is not available.

When (PA) is the optimization problem max_{x∈R}V×Tf\hat{ }(x) obtained by approximating the objective function of the formulated optimization problem (P), the optimization problem (PA) can be written as follows.

$${max}_{\begin{matrix}x ∈ {V \times T}^{} , \\ z ∈ {[ 0 , 1 ]}^{E \times T}\end{matrix}} {\sum }_{t ∈ T} {\sum }_{e = ( u , v ) ∈ E} ( {x}_{vt} + {w}_{et} ) {z}_{et} \qquad [ Math . 4 ]$$

$$s . t . {\sum }_{e ∈ δ ( v )} {z}_{et} \leq {p}_{vt} ( {x}_{vt} ) , ∀ v ∈ V , ∀ t ∈ T ,$$

$${\sum }_{{t}^{′} \leq t} {\sum }_{e ∈ δ ( u )} ϕ ( {c}_{{et}^{′}} , t , {t}^{′} ) {z}_{{et}^{′}} \leq 1 , ∀ u ∈ U , ∀ t ∈ T .$$

With x* obtained by solving this optimization problem (PA), it is possible to obtain a ½ approximation solution for the optimization problem (P). Therefore, when the optimization problem (PA) can be solved rapidly, it possible to rapidly obtain an approximate solution. Therefore, a scheme for solving the optimization problem (PA) at high speed is proposed below.

That is, when the “Assumption” is satisfied, a first constraint of the optimization problem (PA) always holds the equality in a certain optimal solution x*. Therefore, in the optimization problem (PA), xᵥₜ=pᵥₜ⁻¹(Σ_{e∈δ(v)} zₑₜ) is set to define an optimization problem (CP) equivalent to the above optimization problem (PA).

This optimization problem (CP) is represented as

$${max}_{z ∈ {[ 0 , 1 ]}^{E \times T}} {\sum }_{t ∈ T} ( {\sum }_{v ∈ V} {p}_{vt}^{- 1} ( {\sum }_{e ∈ δ ( v )} {z}_{et} ) {\sum }_{e ∈ δ ( v )} {z}_{et} + {\sum }_{e ∈ E} {w}_{et} {z}_{et} ) \qquad [ Math . 5 ]$$

$$s . t . {\sum }_{e ∈ δ ( v )} {z}_{et} ∈ {S}_{vt} , ∀ v ∈ V , ∀ t ∈ T ,$$

$${\sum }_{{t}^{′} \leq t} {\sum }_{e ∈ δ ( u )} ϕ ( {c}_{{et}^{′}} , t , {t}^{′} ) {z}_{{et}^{′}} \leq 1 , ∀ u ∈ U , ∀ t ∈ T .$$

Here, Sᵥₜ is a definition area of a function pᵥₜ⁻¹.

For an optimal value z* of the optimization problem (CP), when x*ᵥₜ:=pᵥₜ⁻¹(Σ_{e∈δ(v)} z*ₑₜ), (x*, z*) is an Optimal solution of the optimization problem (PA).

### (3-3) Solution to Optimization Problem (CP)

Next, a solution to the optimization problem (CP) will be described.

When the “Assumption” (monotone hazard rate function) described above is defined for pᵥₜ(x), the objective function becomes a convex function, which makes it possible to handle this as a convex planning problem. However, the optimization problem (CP) becomes very large with a dimension of a decision variable |E|T. Therefore, in an embodiment, a Primal-Dual Hybrid Gradient method (PDHG method) is applied as a solution.

That is, a Lagrange function of the optimization problem (CP) is

$$L : {{R}_{+}}^{E \times T} \times {{R}_{+}}^{U \times T} \to R ⋃ \{ ∞ \} ,$$

this function can be written as

$$\begin{matrix}[ Math . 6 ] & \\ ℒ ( z , λ ) = {\sum }_{v ∈ V} {\sum }_{t ∈ T} {F}_{vt} ( 〈 1 , {z}_{vt} 〉 ) + 〈 c , z 〉 + 〈 λ , 𝒜 z 〉 + 〈 λ , d 〉 & ( 1 )\end{matrix}$$

Here, zᵥₜ∈R^{δ(v)} is a vector obtained by extracting only a part regarding vertex v∈V and time t∈T from z∈R^{E×T}. Also, c∈R^{E×T} and d∈R^{U×T} are some constant matrices, and A:R^{E×T}→R^{U×T} indicates some linear mapping. Further, Fᵥₜ:R→R∪{∞} indicates a true convex function.

In each iteration of the Primal-Dual Hybrid Gradient method (PDHG method), it is necessary to solve a problem of a form

$$\begin{matrix}[ Math . 7 ] & \\ {min}_{z ∈ {ℝ}_{+}^{E \times T}} ℒ ( z , λ ) + \frac{η}{2} {‖ z - \hat{z} ‖}^{2} , & ( 2 )\end{matrix}$$

$${max}_{λ ∈ {ℝ}_{+}^{U \times T}} ℒ ( z , λ ) - \frac{η}{2} {‖ λ - \hat{λ} ‖}^{2} \qquad ( 3 )$$

for η>0. In the latter equation (3), the optimal solution can be written in a closed form. On the other hand, the objective function in the former equation (2) is a sum of |V|×|T| terms. Therefore, it is sufficient to solve a problem with a small |δ(v)|variable for each of v∈V and t∈T.

Each of the above problems can be written as

$$\begin{matrix}[ Math . 8 ] & \\ {min}_{y ∈ {+}_{n}^{}} {F}_{vt} ( 〈 1 , y 〉 ) + \frac{η}{2} {‖ y - a ‖}^{2} & ( 4 )\end{matrix}$$

Here, n=|δ(v)| and a is a constant vector.

This problem can be easily solved. That is, a variable s is added and the problem is rewritten equivalently to

$$\begin{matrix}[ Math . 9 ] & \\ {min}_{y ∈ {+}_{n}^{} , s ∈} {F}_{vt} ( s ) + \frac{η}{2} {‖ y - a ‖}^{2} , & ( 5 )\end{matrix}$$

$$s . t . 〈 1 , y 〉 = s \qquad ( 6 )$$

When optimality requirements for this problem are considered, for a solution s* of an equation for s

$$\begin{matrix}[ Math . 10 ] & \\ {\sum }_{i = 1}^{n} {( {a}_{i} - \frac{{F}_{vt}^{′} ( s )}{η} )}_{+} = s & ( 7 )\end{matrix}$$

an optimal solution of Equation (4) is

$$y = {( a - \frac{{F}_{vt}^{′} ( {s}^{*} )}{η} 1 )}_{+} \qquad [ Math . 11 ]$$

Since the left side of the above equation broadly monotonically decreases and the right side monotonically increases, this equation has at most one solution, which can be calculated by a bisection method.

Also, it is possible to obtain a solution at a higher speed by applying various well-known acceleration methods to n in Equations (2) and (3) above.

The optimization processing unit 13 stores the optimal solution (x*, z*) obtained as described above in the optimization information storage unit 33, and ends the optimal solution calculation processing.

### (4) Output of Optimal Solution

When the optimal solution (x*, z*) is obtained by the optimization processing unit 13, the control unit 1 of the optimization device OD reads the optimal solution (x*, z*) from the optimization information storage unit 33 and outputs the read optimal solution (x*, z*) from the input and output I/F unit 4 to the online control device PF in step S5 under the control of the optimization information output processing unit 14.

The online control device PF performs processing of allocating the resource u to the user v on the basis of the optimal solution (x*, z*).

### Action and Effects

As described above, in the optimization device OD according to the embodiment, first, a probability function pᵥₜ for each of v∈V and t∈T, the reward wₑₜ when the edge e is matched with each of e∈E and t∈T, the period of time cₑₜ required until the resource u corresponding to a case in which the edge e is used at time t are acquired as parameters, and the optimization problem (P) formulated by using each acquired parameter is defined. Next, when the optimal solution of the optimization problem (P) formulated above is obtained, a determination is made as to whether or not the pre-set “Assumption” is satisfied. When a determination is made that the “assumption” is satisfied, the optimization problem (PA) obtained by approximating the objective function of the optimization problem (P) is defined, the optimization problem (CP) obtained by transforming the optimization problem (PA) is defined, and this optimization problem (CP) is solved by using the Primal-Dual Hybrid Gradient method (PDHG method), to thereby simultaneously obtain both of the variable x that can control the appearance probability of the resource u and the user v and the reward wₑₜ of the edge e and the matching strategy n, as an optimal solution. On the other hand, when a determination is made that the “assumption” is not satisfied, the optimization problem (P) is solved by heuristic solution method, approximate solution method, or the like so that the optimal solution is obtained.

Thus, according to an embodiment, it is possible to simultaneously obtain both of the variable x that can control the appearance probability of the resource u and the user v and the reward wₑₜ of the edge e and the matching strategy n, as an optimal solution.

Further, by providing the online control device PF with the optimal solution obtained by the optimization device OD, the online control device PF can efficiently operate, for example, crowdsourcing for assigning tasks to sequentially appearing workers and a taxi dispatch service for allocating available taxi to sequentially appearing users, thereby making it possible to improve the profits of the online service.

### OTHER EMBODIMENTS

In the embodiment, a case in which the optimization device OD is provided as an device separate from the online control device PF has been described as an example. However, the present invention is not limited thereto, and for example, the optimization device OD may be provided to operate as one of functions within the online control device PF. Further, when a plurality of online control devices PF are present according to the type of service, the optimization device OD and the plurality of online control devices PF are connected via a network so that the plurality of online control devices PF are configured to share one optimization devices OD.

In addition, the hardware configuration and functional configuration of the optimization device, the processing procedure and processing content of the optimization device, types and content of the online services in the application system to which online matching has been applied, and the like can be variously modified without departing from the gist of the present invention.

Although the embodiments of the present invention have been described in detail above, the above description is merely illustrative of the present invention in every respect. It goes without saying that various modifications and variations can be made without departing from the scope of the invention. That is, a specific configuration according to the embodiment may be appropriately adopted in implementing the present invention.

In short, the present invention is not limited to the embodiments as they are, and can be embodied by modifying constituent elements without departing from the scope of the present invention at the implementation stage. Further, various inventions can be formed by appropriate combinations of the plurality of constituent elements disclosed in the above embodiments. For example, some components may be omitted from all components shown in the embodiments. Furthermore, constituent elements of different embodiments may be combined appropriately.

### REFERENCE SIGNS LIST

OD Optimizer
PF Online control device
NW Network
TM1 to TMn User terminal
1 Control unit
2 Program storage unit
3 Data storage unit
4 Input and output I/F unit
5 Bus
11 Parameter acquisition processing unit
12 Formulation processing unit
13 Optimization processing unit
14 Optimization information output processing unit
31 Parameter storage unit
32 Formulation information storage unit
33 Optimization information storage unit

1. An online matching optimization device used to determine an optimal solution from an optimization problem defined in online matching for allocating a second node prepared in advance to a first node appearing at an arbitrary time, the online matching optimization device comprising:
a parameter acquisition processing unit configured to acquire parameter information including a probability function defining an appearance probability of the first node for a plurality of times, a reward assigned when an edge is matched with a set of edges associating a set of first nodes with a set of second nodes for the plurality of times, and a period of time required until the second node corresponding to the matched edge is available again for the plurality of times;
a formulation processing unit configured to define a first optimization problem formulated using the acquired parameter information; and
an optimization processing unit configured to determine, by solving the formulated first optimization problem, a variable for controlling the reward of the edge and the appearance probability, and a matching strategy for designating the second node to be allocated to the appearing first node as the optimal solution; and
an output processing unit configured to output the determined variables and matching strategy.

2. The online matching optimization device according to claim 1, wherein the optimization processing unit includes:
processing for defining a second optimization problem obtained by approximating an objective function of the formulated first optimization problem; and
processing for determining the variable and the matching strategy as the optimal solution by solving the defined second optimization problem.

3. The online matching optimization device according to claim 1, wherein the optimization processing unit includes:
processing for defining a second optimization problem obtained by approximating an objective function of the formulated first optimization problem; and
processing for defining a third optimization problem in which the objective function is transformed into a convex function by applying a preset assumption to the defined second optimization problem; and
processing for determining the variable and the matching strategy as the optimal solution by solving the third optimization problem.

4. The online matching optimization device according to claim 3, wherein the optimization processing unit determines the variable and the matching strategy as the optimal solution by solving the third optimization problem using a Primal-Dual Hybrid Gradient method.

5. An online matching optimization method executed by a device used to determine an optimal solution from an optimization problem defined in online matching for allocating a second node prepared in advance to a first node appearing at an arbitrary time, the online matching optimization method comprising:
acquiring parameter information including a probability function defining an appearance probability of the first node for a plurality of times, a reward assigned when an edge is matched with a set of edges associating a set of first nodes with a set of second nodes for the plurality of times, and a period of time required until the second node corresponding to the matched edge is available again for the plurality of times;
defining a first optimization problem formulated using the acquired parameter information; and
determining, by solving the formulated first optimization problem, a variable for controlling the reward of the edge and the appearance probability, and a matching strategy for designating the second node to be allocated to the appearing first node as the optimal solution; and
outputting the determined variables and matching strategy.

6. A non-transitory computer readable storage medium storing a computer program which is executed by an online matching optimization device used to determine an optimal solution from an optimization problem defined in online matching for allocating a second node prepared in advance to a first node appearing at an arbitrary time, the computer program providing the steps of:
acquiring parameter information including a probability function defining an appearance probability of the first node for a plurality of times, a reward assigned when an edge is matched with a set of edges associating a set of first nodes with a set of second nodes for the plurality of times, and a period of time required until the second node corresponding to the matched edge is available again for the plurality of times;
defining a first optimization problem formulated using the acquired parameter information; and
determining, by solving the formulated first optimization problem, a variable for controlling the reward of the edge and the appearance probability, and a matching strategy for designating the second node to be allocated to the appearing first node as the optimal solution; and
outputting the determined variables and matching strategy.
